(19) United States
(12) Patent Application Publication
(10) Pub. No.: US 2025/0366405 A1
(43) Pub. Date: Dec. 4, 2025

(54) Electrosignaling of Young Seedlings For Higher Yield Using a Short Time Medium Wavelength Infrared and Ultraviolet Illumination Signal

(71) Applicants: Jonathan A. JACKSON, DAYTON, OH (US); Patrick A. JACKSON, XENIA, OH (US)

(72) Inventors: Jonathan A. JACKSON, DAYTON, OH (US); Patrick A. JACKSON, XENIA, OH (US)

(21) Appl. No.: 18/680,680

(22) Filed: May 31, 2024

(51) Int. Cl. A01G 7/04

(52) U.S. Cl. CPC A01G 7/045

(57) ABSTRACT

A method for electrosignaling to obtain higher crop yield from non-reproductive vegetative stage young plant seedlings engaged in photosynthesis. A short time precisely specified mandatory dual wavelength distribution illumination signal comprising Medium Wavelength Infrared (MWIR) and an Ultraviolet Illumination Distribution (UVID) is administered to the plant with precise ranges of limited extent for irradiance values and cumulative deposited energies.

A one-time 10-second exposure of soybean seedlings to the illumination signal improved crop yield by up to 20%. Preferred embodiments include a moveable cultivator to provide the electrosignaling on an agricultural field, as well as a field so treated.

The method inducing this electrosignaling effect does not take place during typical illumination, such as illuminating to supplement sunlight or grow light.

### CROSS-REFERENCE TO RELATED APPLICATION

This application claims the benefit of US Provisional Patent Application No. 63/472,152, filed 9 Jun. 2023, which is incorporated by reference herein in its entirety.

### TECHNICAL FIELD

This invention relates to a discovery involving a method for electrosignaling of growing plants to obtain higher yield, by delivering short-time unnatural illumination to a non-reproductive stage young plant seedling that is already engaged in photosynthesis.

The discovery involves illuminating young seedlings with a rapid narrow range, irradiance-sensitive and cumulative energy-sensitive electromagnetic radiation exposure.

The invention does not involve open-ended or long-term exposure such as upon land or any floor or table such as in a greenhouse or grow house. Rather, the exposure is rapid and intense for a limited time, typically on the order of seconds. The invention does not use very high radiative energy transfers in any energy or wavelength that would cause scalding, heat shock, incineration, plant component damage or the like, and has a minimum irradiance which is high relative to grow lamps and sunlight.

### BACKGROUND OF THE INVENTION

Agriculture and food industries represent approximately $1 trillion of US GDP (Gross Domestic Product), much of it direct output from over 2 million farms on nearly 900 million acres of land. Modern farming has become a highly-intensive endeavor involving large relative amounts of financial investment and risk, use of complex and expensive equipment, skill and mastery over complex farming techniques and operations, and acutely focused attention to, and knowledge of, crop and animal biology; environments created by weather, effects of soil and decomposing biological matter, and many varied actions of competing plants, animals and microorganisms.

In agricultural grain production, desirable yield known generally as cash crops or grains can include small seed grains, like alfalfa, canola, flax, grass seeds, millet, mustard, oats, rape seed, rice, rye and triicale; medium-size seeds, like barley, lentils, popcorn, safflower, sorghum, and wheat; and large seeds, like chickpeas, corn, edible beans, lupins, navy beans, peas, soybeans and sunflowers. The progress and extent of seed germination, and later establishment of root mass and plant components like stalks are important for crop yields and for profitable and viable farm operations worldwide. This disclosure concerns obtaining higher yields, and after germination, continued growth of young seedlings in a vegetative growth stage and active in photosynthesis is paramount to profitable and productive farm operations.

Recent research has shown that plants have complex systems of perception and signaling, including internal signaling to respond to various abiotic stresses. Internal long distance signals include slow moving action potentials, variation potentials and systemic potentials. Action potentials are initiated at the cellular level by influx of calcium Ca²⁺ though calcium channels. Much about the complex physiological and electrical phenomena is still unknown. Signaling cascades have been identified, including those giving rise to effects allowable via cryptochromes, phytochromes and phototropins. Excess light has been implicated in ROS (Reaction Oxygen Species) induced damage. See [Ref] Electrical Signaling of Plants under Abiotic Stressors: Transmission of Stimulus-Specific Information, Int J Mol Sci. 2021 October; 22(19): 10715, hereby incorporated by reference herein in its entirety.

The invention relates to a kind of electrosignaling that apparently causes young seedlings in a vegetative growth stage to be permanently changed or programmed for higher yield in as little as 10 seconds. But it is still unknown as to exactly why this phenomenon occurs.

Now referring to FIG. 1, a schematic representation of a general electromagnetic spectrum for wavelengths of radiation of significance that are potentially incident upon a plant, with wavelengths ranging from 1 mm to less than 100 nm, is shown. In the infrared portion, or heat radiation portion of the electromagnetic spectrum, there are subdivisions for Far-Infrared (FAR), mid or Medium Wavelength Infrared (MWIR) and near-infrared (NEAR) all in total ranging from 1 mm to 700 nm or 0.7 microns. Visible light (Visible Light) is commonly taken to range from 700 nm to 400 nm. Ultraviolet (Ultraviolet) radiation is generally taken to be of wavelength less than 400 nm, with near-ultraviolet further divided according to some consensus into known portions UV-A (400-320 nm), UV-B (320-280 nm) and finally, UV-C (280 nm-100 nm) which is extremely dangerous for humans and is often used as a germicidal radiation to purify water and kill bacteria, viruses, and other organisms.

There are competing standards for labeling portions of the electromagnetic spectrum, as promulgated by ISO (International Organization for Standardization); DIN (Deutsches Institut für Normung e.V). (German Institute for Standardization) and others.

It is important to note that in this disclosure and the appended claims, these and certain other subdivisions shall have particular meanings assigned here and will be defined herein in the Definitions Section below.

Now referring to FIG. 2, a cartesian plot of both unfiltered solar radiation and net (ground) solar radiation is shown, with spectral radiance in watts per square meter per nanometer versus wavelength in nanometers (nm) is shown. Photosynthesis in plants makes use of visible light, especially blue and red visible light, and ultraviolet light, to varying degrees, depending on a host of factors including plant species and type, radiation exposure history, chloroplast type, internal plant signaling, light exposure history, and other factors. Note that nearly all the natural infrared radiation in sunlight is essentially in the region in or about near infrared (NIR), with wavelength shorter than 2 micrometers. This is in contrast to the unnatural illumination taught and claimed in the instant disclosure.

Approximately seven percent of the raw electromagnetic radiation emitted from the sun is in a UV range of about 200-400 nm wavelengths. As the solar radiation passes through the atmosphere, ultraviolet or UV radiation flux is reduced, allowing that UV-C (“shortwave”) radiation (200-280 nm) is completely absorbed by atmospheric gases, while much of the UV-B radiation (280-320 nm) is additionally absorbed by stratospheric ozone, with a small amount transmitted to the Earth's surface. Solar UV-A radiation (320-400 nm) is essentially, for practical purposes, not absorbed by the ozone layer.

Abiotic stresses on plants such as excess salinity, drought, flooding, heat, cold, freezing, excessive light, UV radiation, and heavy metal toxicity are considered to negatively impact crop yield. Prior art grow lamps, luminaires and radiation treatments that teach the use of sterilizing or other radiations to eliminate fungus and pathogens and pests do not exploit the effect discovered, of being able to apply a one-time illumination signal to produce later a higher yield.

U.S. Pat. No. 2,300,727 to Durling is a topical anti-fungal illumination method with required turning over of seeds for best results, and Durling is silent about treating seedlings, and about the role of UV light expressed herein in the instant disclosure.

The discovery is a method for electrosignaling to obtain higher crop yield from non-reproductive vegetative stage young plant seedlings engaged in photosynthesis. A short time precisely specified mandatory dual wavelength distribution illumination signal comprising Medium Wavelength Infrared and an Ultraviolet Illumination Distribution is administered to the plant with precise ranges of limited extent for irradiance values and cumulative deposited energies. Prior art application of electromagnetic radiation to plants do not teach or suggest this discovery, [a] including the application of radiation taking the form of a short time illumination signal pulse; [b] including its specific and hidden nature, not discoverable by those who are illuminating to supplement sunlight on an ongoing basis; and [c] obtaining increased yield during later growth and not simply providing sterilization or treating biotic stress due to living organisms from fungi, viruses, bacteria and insects.

### SUMMARY OF THE INVENTION

A method for electrosignaling to obtain higher yield from a non-reproductive stage young plant seedling (PLANT) engaged in photosynthesis was discovered. A short time illumination signal is administered to the plant subject to precise ranges for wavelengths, and with precise ranges of limited extent for irradiance values and cumulative deposited energies. This protocol is hidden in that it does not have effect evident to those who are illuminating to supplement sunlight or grow light on an ongoing basis, or illuminating for sterilization or treating biotic stress due to living organisms from fungi, viruses, bacteria and insects.

A one-time 10-second exposure of soybean seedlings to the illumination signal improved crop yield by up to 20%.

The invention can include a method for electrosignaling to obtain higher yield from a non-reproductive stage young plant seedling (PLANT) engaged in photosynthesis, the method comprising:
delivering to the young plant seedling an unnatural short time illumination signal by illuminating the young plant seedling with exposures to Medium Wavelength Infrared MWIR radiation, and also to an Ultraviolet Illumination Distribution UVID, with the illuminating precisely so formed and arrayed and timed to illuminate the seedling such that
[a] the Medium Wavelength Infrared radiation has a minimum average irradiance of 0.2 Watt /cm² and a maximum average irradiance of 1 Watt/cm²; and also has a minimum cumulative deposited energy of % A Joule/cm² and a maximum cumulative deposited energy of 15 Joules/cm²; and
[b] the Ultraviolet Illumination Distribution has a minimum average irradiance of 0.01 Watt/cm² and a maximum average irradiance of 1 Watt/cm², and also has a minimum cumulative deposited energy of 0.2 Joule/cm² and a maximum cumulative deposited energy of 4 Joules/cm².

The invention can also include a moveable cultivator (MOVEABLE CULTIVATOR) to provide electrosignaling to obtain higher yield from non-reproductive stage young plant seedlings (PLANT) engaged in photosynthesis, with the moveable cultivator comprising: an illuminator (IE9) so formed, arrayed, located, positioned, operated and energized to deliver to the young plant seedlings an unnatural short time illumination signal by illuminating the young plant seedlings with exposures to Medium Wavelength Infrared (MWIR) radiation, and also to an Ultraviolet Illumination Distribution (UVID); the moveable cultivator so formed, moved and energized to move along a field comprising the young plant seedlings, such that the illuminator can move and illuminate precisely the young plant seedlings with [a] Medium Wavelength Infrared radiation having a minimum average irradiance of 0.2 Watt/cm² and a maximum average irradiance of 1 Watt/cm²; and also having a minimum cumulative deposited energy of ½ Joule/cm² and a maximum cumulative deposited energy of Joules/cm²; and also illuminate precisely the young plant seedlings with an [b] Ultraviolet Illumination Distribution having a minimum average irradiance of 0.01 Watt/cm² and a maximum average irradiance of 1 Watt/cm², and also having a minimum cumulative deposited energy of 0.2 Joule/cm² and a maximum cumulative deposited energy of 4 Joules/cm².

The invention can also include an agricultural field, comprising:
a field (FIELD) comprising non-reproductive stage young plant seedlings (PLANT) engaged in photosynthesis that have undergone electrosignaling to obtain higher yield wherein the young plant seedlings have received an unnatural short time illumination signal comprising illumination exposures to Medium Wavelength Infrared MWIR radiation, and also to an Ultraviolet Illumination Distribution UVID; the illumination exposures precisely so formed and arrayed and timed to have illuminated the seedlings such that
[a] the Medium Wavelength Infrared radiation had a minimum average irradiance of 0.2 Watt/cm² and a maximum average irradiance of 1 Watt/cm²; and also had a minimum cumulative deposited energy of % A Joule/cm² and a maximum cumulative deposited energy of 15 Joules/cm²; and
[b] the Ultraviolet Illumination Distribution had a minimum average irradiance of 0.01 Watt/cm² and a maximum average irradiance of 1 Watt/cm², and also had a minimum cumulative deposited energy of 0.2 Joule/cm² and a maximum cumulative deposited energy of 4 Joules/cm².

The Ultraviolet Illumination Distribution radiation used in the method can optionally comprise any of UV-A, UV-B radiation and indigo/violet radiation of wavelength 400-420 nm, for a total possible wavelength range of 280 nm-420 nm; and the Ultraviolet Illumination Distribution can optionally comprise relative peaks at about 315 nm and 370 nm wavelength.

A high intensity discharge lamp HID can be used to provide the Ultraviolet Illumination Distribution, and the Medium Wavelength Infrared radiation is provided at least in part by any of borosilicate glass, soda lime glass, silica fusion glass, and aluminum oxide ceramic in thermal communication with at least part of the high intensity discharge lamp.

In a preferred embodiment, the illuminating can originate from, and move with, a moveable cultivator that moves along a field, allowing exposures according to the invention to multiple plants in that field.

Optionally, the exposures of the Medium Wavelength Infrared and the Ultraviolet Illumination Distribution occur at least in part non-simultaneously.

Preferred narrow specific ranges can be employed, such as Medium Wavelength Infrared, where the narrow specific range of cumulative deposited illumination energy can be one of: % Joule/cm² to 4 Joules/cm²; 2 Joule/cm² to 5 Joules/cm²; ½ Joule/cm² to 6 Joules/cm²; 2 Joule/cm² to 7 Joules/cm²; ½ Joule/cm² to 8 Joules/cm²; 2 Joule/cm² to 9 Joules/cm²; ½ Joule/cm² to 10 Joules/cm²; ½ Joule/cm² to 11 Joules/cm²; ½ Joule/cm² to 12 Joules/cm²; ½ Joule/cm² to 13 Joules/cm²; ½ Joule/cm² to 14 Joules/cm²; and ½ Joule/cm² to 15 Joules/cm², and the minimum average irradiance can be selected from any of 0.3 W/cm², 0.4 W/cm², 0.5 W/cm², 0.6 W/cm², 0.7 W/cm², 0.8 W/cm², 0.9 W/cm², and 1.0 W/cm². Similar breakdowns of range can be used for an Ultraviolet Illumination Distribution according to the invention.

### BRIEF DESCRIPTION OF THE DRAWINGS

FIG. 1 shows a schematic representation of a general electromagnetic spectrum for wavelengths potentially incident from the sun, with wavelengths ranging from 1 mm to less than 100 nm;

FIG. 2 shows a typical natural filtered and unfiltered solar radiation spectrum using a cartesian plot of spectral radiance versus wavelength;

FIG. 3 shows a part surface view, part oblique cutout view of major components of an illustrative agricultural seed;

FIG. 4 shows a cross-sectional view of certain illustrative components of a dicot;

FIG. 5 shows a basic view of a seed after germination and emergence of a radicle;

FIG. 6 shows the schematic representation of a general electromagnetic spectrum for wavelengths incident from the sun of FIG. 1, with a total maximum irradiance of approximately 0.1 W/cm²;

FIGS. 7 and 8 show a schematic representation of a method according to the invention relating to a discovery involving electrosignaling of growing plants to obtain higher yield, by delivering a short-time unnatural illumination signal;

FIG. 9 shows hidden exposure parameters that help define a short time illumination signal according to the invention;

FIG. 10 shows a schematic representation of action that results from electrosignaling of a plant;

FIG. 11 shows a schematic representation across the one preferred range of 280 nm to 400 nm for an Ultraviolet Illumination Distribution with various illustrative possible distribution patterns;

FIG. 12 shows three illustrative cartesian plots of spectral density versus wavelength for three possible Medium Wavelength Infrared light sources for service to the instant invention;

FIG. 13 shows a cross-sectional schematic view of a Medium Wavelength Infrared (MWIR) emitter that employs an emissive powder coat for enhanced emission;

FIGS. 14, 15 and 16 show oblique surface views of various LED driven ultraviolet light sources that can be employed in service of the instant invention;

FIGS. 17, 18 and 19 show a schematic view, cutout oblique view, and a combination cross-sectional and surface view, respectively, of dual source consolidated light sources as preferred embodiments to practice the instant invention;

FIGS. 20 and 21 show cross-sectional representations of an illustrative proximity pass-through configuration illuminator according to the invention;

FIGS. 22 and 23 show oblique surface views of the compact illuminator in service of the instant invention;

FIG. 24 shows a schematic depicting MWIR and UVID sources to illuminate young seedlings in a field using a moveable cultivator according to the invention;

FIG. 25 shows exposure protocol for Medium Wavelength Infrared radiation according to the invention, by depicting an Exposure Specific Illumination Signaling island, on a cartesian plot of Cumulative Deposited Energy versus Average Irradiance; and

FIG. 26 shows exposure protocol for an Ultraviolet Illumination Distribution according to the invention, by depicting an Exposure Specific Illumination Signaling island, on a cartesian plot of Cumulative Deposited Energy versus Average Irradiance.

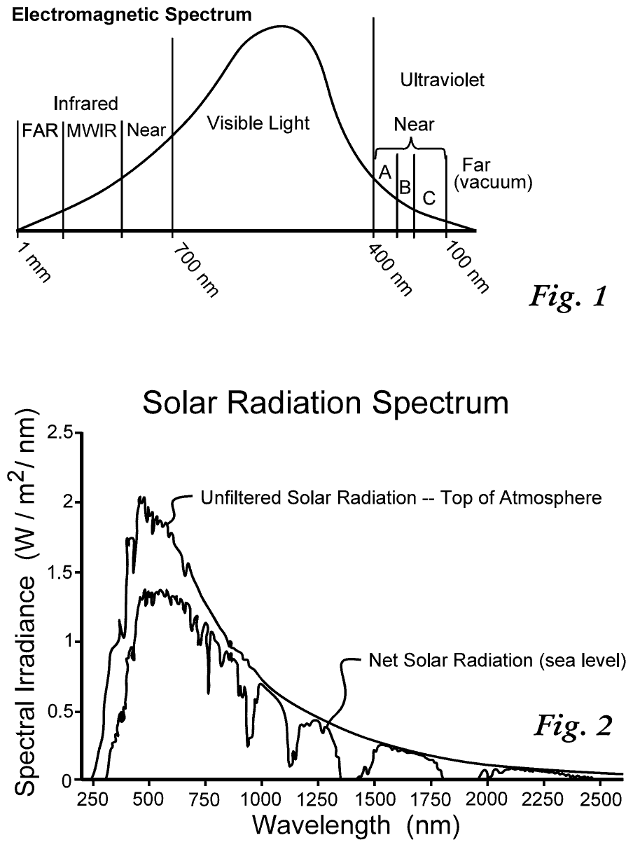

### DEFINITIONS

The following definitions shall be used throughout:

Cultivator, Moveable Cultivator—shall comprise vehicle, cart, cultivator implement, machinery, wagon, housing or moving frame, whether self-powered, externally powered, self-propelled, or drawn by other equipment as known in the agricultural arts, regardless of whether or not it is expressly or implicitly rededicated from another purpose.

Cumulative deposited energy (in Joules/cm²)—shall refer to deposited energy above ambient conditions as a result of practicing the instant invention, and shall not refer to sunlight or grow light in a greenhouse or grow house.

Electrosignaling—shall include internal electrical signaling inside a plant, as well as the aspect of electromagnetic signaling of a plant due to radiation exposures as taught and claimed herein.

Exposure—in the appended claims shall denote a process of illumination that shall include stepwise, piecemeal, segmented, separated, sequential, variable, or modulated exposures that when totaled, have a summed duration to follow the specification provided as taught and found in the appended claims, such as three 5-second exposures/flashes over a minute time, or four ¼ second flashes in ten seconds. Average irradiances as taught and claimed herein shall nonetheless apply to extended time periods. If a given minimum average irradiance for Medium Wavelength Infrared or an Ultraviolet Illumination Distribution is achieved during at least part of an irradiation, it shall be deemed to be reading upon the appended claims. See “Method” in this Definitions Section.

Field—shall include any agricultural surface comprising plants, whether outside (such as on a farm), or inside a greenhouse or growing facility, and also include any such surface, place, array or arrangement upon which the instant invention is practiced.

Heater/Heating—shall include all thermal production and transfer, from any heat source, via contact or conduction; convection; or radiation, or resonance.

Illuminate/Illumination/Illuminating—shall denote any net transmission of electromagnetic radiation as taught and claimed here, whether by direct illumination or via reflection or indirect transmission, such as via use of mirrors, light guides, via refraction, or incidental reflection or absorption and re-transmission through any material body, or through a seedling under treatment, such as light passing between or through one or more seedlings to another seedling. Illumination shall be interpreted broadly and shall include all manner of radiative processes and exposures as defined by the appended claims, and shall not be limited to lamp outputs, but rather shall encompass any and all radiation afforded by physical processes such as incandescence or any light emission process such as from a light emitting diode (LED); flames; or incandescence from hot masses, such as gases, fluids, steam, metal knives or hot infrared emitters—and can encompass multiple sources. Lamps shown illustratively in this disclosure shall not be considered limiting, in view of the appended claims.

Illuminator—shall denote light sources as taught herein for practicing the instant invention.

Irradiance—shall refer to light energy added to ambient lighting conditions, over and above that provided by sunlight or grow light in a greenhouse or grow house.

Mandatory Twin Irradiation shall include simultaneous or near-simultaneous exposure to Medium Wavelength Infrared and an Ultraviolet Illumination Distribution, or separate exposures thereto.

Medium Wavelength Infrared—MWIR—has been variously defined by different international organizational bodies, sometimes using different terms. For example In the CIE division scheme (International Commission on Illumination), CIE recommended the division of infrared radiation into the following three bands using letter abbreviations: IR-A, from 700 nm-1400 nm (0.7 μm-1.4 μm); IR-B, from 1400 nm-3000 nm (1.4 μm-3 μm); and IR-C from 3000 nm-1 mm (3 μm-1000 μm). ISO (International Organization for Standardization) established a standard, ISO20473 that defines the term mid-IR to mean radiation with wavelengths from 3-50 microns. In common literature infrared generally has been divided into near infrared (0.7 to 1.4 microns IRA, IR-A DIN), short wavelength infrared (SWIR or 1.4-3.0 microns IR-B DIN), mid-wavelength (or medium wavelength) infrared at 3-8 microns (MWIR or mid IR 3-8 microns IR-C DIN) to long wavelength infrared (LWIR, IR-C DIN) 8-15 microns to far infrared 15-1000 microns. In this disclosure, throughout the specification, drawings and in the appended claims, MWIR in particular shall have a meaning assigned, and the wavelengths for MWIR shall span from 2-20 microns, and with preferred embodiments in a range of 2-8 microns and sometimes more preferably in a range of 2-5 microns. Source emissions can include emissions from an MWIR emitter E that is formed from materials with known emissivity functions useful in service of the invention, such as known borosilicate glass.

Method—such as referred to in the instant disclosure and appended claims, can be a process or method as taught and claimed herein that is continuous in time, or non-continuous, including piecewise, piecemeal, stepped, interrupted or delayed application of the methods of the instant invention, and shall also refer to any method or process for which at least portion of which occurs in real time. Average irradiances as taught and claimed herein shall nonetheless apply.

MWIR Emitter (E)—shall denote any glass or material body that has the requisite optical properties or electromagnetic emissivity properties that allow service to the instant invention as described in the appended claims. This can include glass known under the trade name Pyrex® such as borosilicate glass, which is preferred, or Pyrex Glass Code 7740, as well as Pyrex® soda lime glass or other materials, such as aluminum oxide ceramic. Any material body which serves the invention with useful emissivity as an MWIR emitter when stimulated, excited, or heated shall meet this definition. An Ultraviolet Illumination Distribution UVID emitter and a MWIR emitter can be combined into one body or component.

Motion/in motion—shall include all generally moving states of a cultivator or light source, including [1] continuous motion; [2] stepwise motion that can include pauses, starts and stops, or even has reversals—in any combination; and motion induced by vibratory elements or supports that cause a process according to the invention to generally progress, but not always progress, in space.

Powder coat—shall include any and all coverings, coatings, surface treatments, appliques, and depositions to a surface, including using materials as disclosed, such as borosilicate glass, Pyrex® Glass Code 7740, soda lime glass, aluminum oxide ceramic.

Seedling—shall include all known seedlings, such as derived from grown outcrossed, inbred, or hybrid seeds or embryonic plants, or encased plant embyros.

UVID/Ultraviolet Illumination Distribution—shall denote a particular range of illumination wavelengths such as emitted by commercially available ultraviolet LED (light emitting diode) or HID (High Intensity Discharge) lamps or light sources. This range of wavelengths serves the instant invention. This definition shall include an Ultraviolet Illumination Distribution to be defined to be any of the following wavelength ranges:
[1] A preferred range of 350-400 nm; [2] another preferred range of 315-400 nm; [3] another preferred range of 280-400 nm; [4] another preferred range of 315-420 nm; [5] another preferred range of 280-420 nm, and [6] another preferred range of 280-420 nm. This set of ranges shall control over any particular perceived “color” and does not have to include wavelengths that could be associated with common human color perceptions. The addition of light for any reason, including for a trademark or appearance effect, e.g., aquamarine, or for operator safety, e.g., orange, shall not affect this definition. An Ultraviolet Illumination Distribution UVID can include monochromatic, multi-chromatic frequency/wavelength lines or bands, continuous or non-continuous distributions, and distributions that comprise one of more emission lines, or distributions that are absent a general wavelength or frequency for which it is named, i.e., a distribution that is absent wavelengths in a portion of ultraviolet, such as absent 280-320 nm. Metamerism or other specific response of the human visual system to identify or form particular color perceptions shall not narrow this definition.

Yield—as in obtaining higher yield, shall refer to any of a higher crop yield, or a higher number of flowers, blossoms, seed pods, seeds or leaves for a given plant during all or a portion of its growth stages.

UVID emitter (99)—shall denote any light producing device that has the requisite electromagnetic output properties to help produce an Ultraviolet Illumination Distribution UVID that allows service to the instant invention as described in the appended claims, and can be illustratively an LED array UVID emitter 99; a laser; or an electronically excited material body. An UVID emitter and a MWIR emitter can be combined into one body or component, or device.

Wavelength distribution—shall include any and all distributions, including continuous, spectral or other distributions of radiation in a given wavelength distribution range. For example, a wavelength distribution according to the claimed invention can comprise primarily only Medium Wavelength Infrared (MWIR) of wavelengths 2-8 microns, and an Ultraviolet Illumination Distribution UVID of wavelengths primarily around 395 nm, or alternatively, a distribution from 280 nm-400 nm comprising relative peaks at 315 nm and 370 nm.

### DETAILED DESCRIPTION

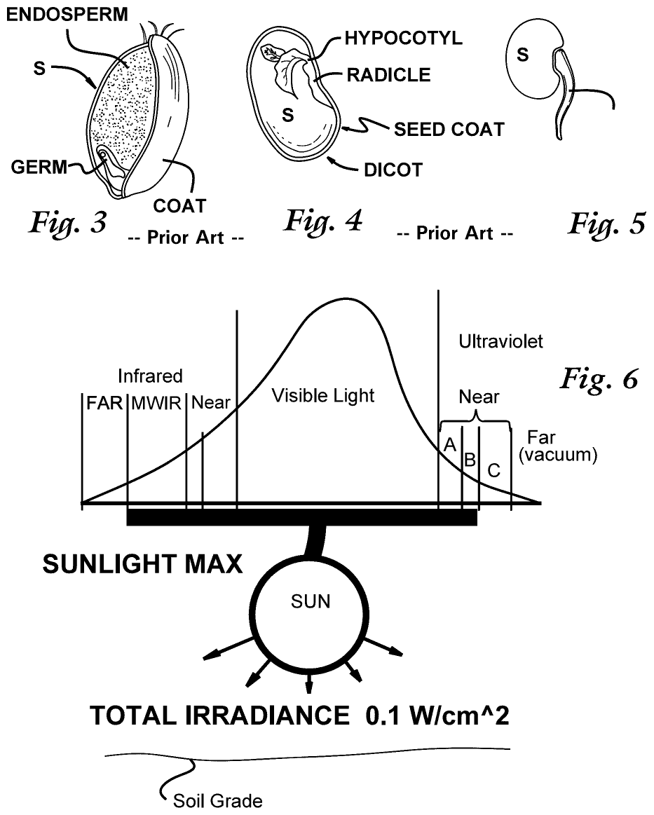

Referring now to FIG. 3, a part surface view, part oblique cutout view of major components of an illustrative agricultural seed are shown. Seed S is shown comprising an endosperm (ENDOSPERM), a food store for a later developing plant embryo; a germ (GERM) or embryo of the seed; and an outer coat (COAT) which figures importantly in the exposures taught and claimed in this disclosure. Typical sizes for seed S range from 0.025 inch (0.6 mm) to 0.25 inches (6.4 mm).

Referring now to FIG. 4, a cross-sectional view of some illustrative components of a dicot (dicotyledon) are shown. A dicot is shown illustratively, possessing a radicle (RADICLE), which is typically the first part of the seed that emerges upon germination. As the embryonic root of the plant, it supports the hypocotyl (HYPOCOTYL) as shown, which essentially acts as an embryonic stem of the seed S that would emerge upon germination. Attached to this embryonic stem are two leaves as shown.

This disclosure concerns the time after germination when seeds become seedlings and it relates to seedlings of all types, among them monocotyldons and dicotyledons. Monocotyledons (associated with one seed leaf, not shown) and dicotlydons (associated with two seed leaves, shown attached to the radicle) differ in early seedling development. In monocotyledons, a primary root is protected by a coating, a coleorhiza, which ejects itself to yield to allow seedling leaves to appear, which are in turn protected by another coating, a coleoptile. With dicotyledons a primary root radicle grows, anchoring the seedling to the ground, and further growth of leaves occurs. Either way, germination is marked by the growth and development of the radicle, and allowing the full development of a healthy plant.

Referring now to FIG. 5, a basic view of a seed after germination and emergence of a radicle is shown. This is an elongation, as shown, of the embryonic axis from seed allowing subsequent seedling emergence. The teachings of this disclosure concerns later growth stages, namely germinated plants that have emerged from soil, as discussed below.

Now referring to FIG. 6, a schematic representation of a general electromagnetic spectrum for wavelengths incident from the sun is shown. A typical figure for maximum solar power irradiance at the equator is 1000 Watts/meter² or 0.1 W/cm². This is significantly less than the minimum average irradiances and preferred irradiance taught and claimed in this disclosure, for just two narrow bands of wavelength, namely, Medium Wavelength Infrared and ultraviolet. For this and other reasons, the illumination taught and claimed herein is unnatural.

Electrosignaling as taught and claimed in the instant disclosure was discovered to improve yield, in terms of flowers and pods grown, and also crop yield.

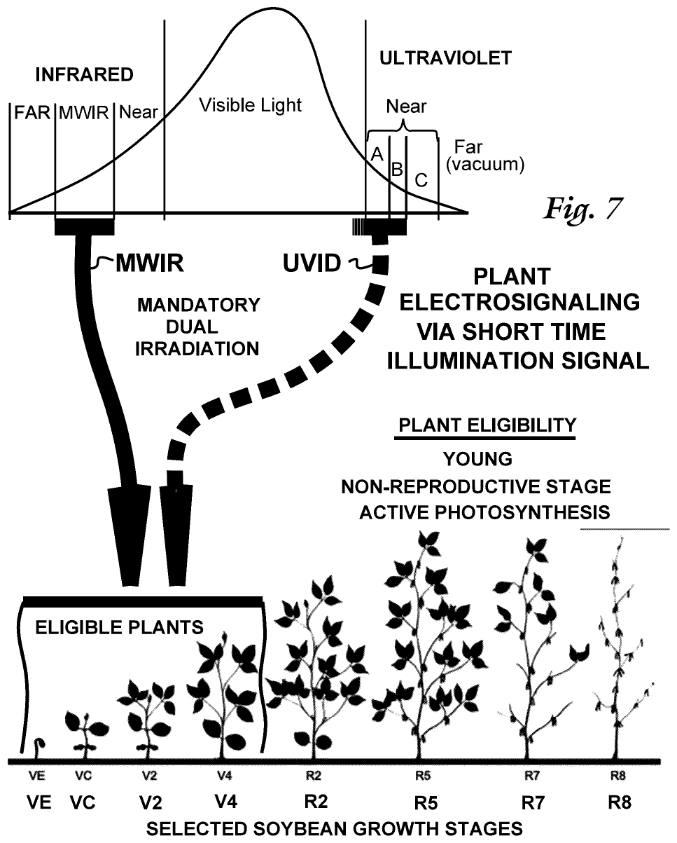

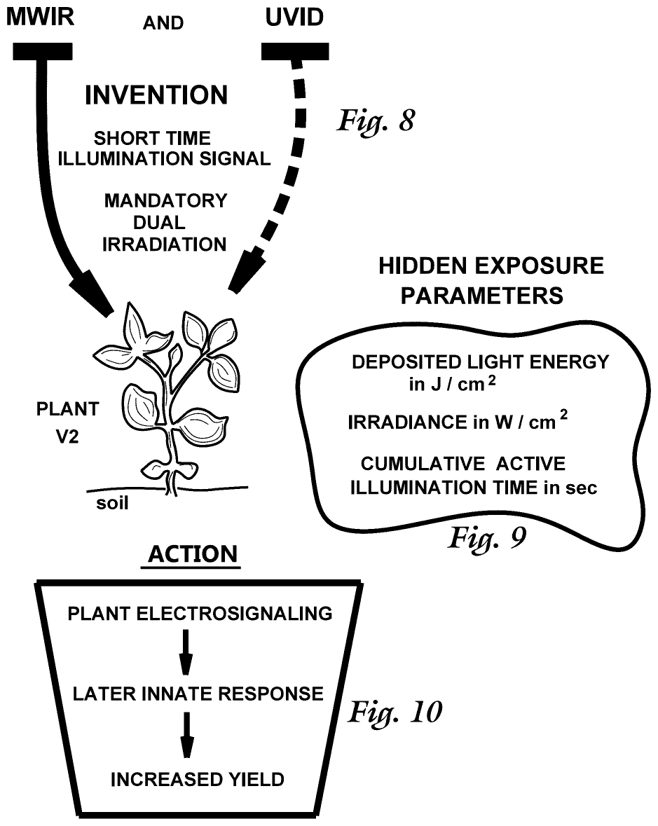

Now referring to FIGS. 7 and 8, a schematic representation is shown of a method according to the invention relating to a discovery involving electrosignaling of growing plants to obtain higher yield, by delivering a short-time unnatural illumination signal. The invention acts upon eligible plants, as discussed below.

In the instant disclosure, soybeans are discussed in detail illustratively.

When a soybean plant first emerges from the soil, and its cotyledon is visible, its growth stage is known in the art as VE stage (Vegetative emergent). When the first pair of unifoliate leaves are present, the plant is at VC stage (Vegetative cotyledon). Vegetative growth stages are later tracked by counting the number of stems with trifoliate leaves on the plant. A soybean plant with 2 stems with trifoliate leaves is at stage V2, while a plant with 3 stems with trifoliate leaves is V3, and so on.

Herein we adopt a set of criteria to judge soybean plant growth stages from Perdue University Field Crops IPM/and further from “How a Soybean Plant Develops,” Special Report No. 53, Iowa State University, reprinted March, 1994, which document is hereby incorporated by reference herein in its entirety.

This identification system divides plant development into vegetative (V) and reproductive (R) stages. With the exception of the first two stages, the (V) stages are designated numerically as V1, V2, V3, etc. through V(n) where (n) represents the number for the last node stage of a specific variety. The (n) will fluctuate with variety and environmental differences. Eight R stages are simply designated numerically.

V stages following VC are numbered according to the uppermost fully developed leaf node. One starts with the unifoliolate leaf node when counting the number of fully developed leaf nodes. A leaf node is fully developed when the leaf above it has leaflets which are fully unrolled. That is, the leaflet edges are no longer touching. Stages include:

### Soybean Vegetative Stages

| Stage | Description |
|---|---|
| VE | Emergence |
| VC | Cotyledon |
| V1 | Unifoliolate and first trifoliolate leaves |
| | are fully developed |
| V2 | Unifoliolate and first two trifoliolate |
| | leaves are fully developed |
| V3 | Unifoliolate and first three trifoliolate |
| | leaves are fully developed |
| V(n) | Unifoliolate and (n) trifoliolate leaves |
| | are fully developed |

### Reproductive Stages

| Stage | Description |
|---|---|
| R1 | Open flower at any node on the main stem |
| R2 | Open flower at one of the two uppermost nodes on the main |
| | stem with a fully developed leaf |
| R3 | Pod is 5 mm ( 3/16 inch) long at one of the four |
| | uppermost nodes on the main stem with a fully developed leaf |
| R4 | Pod is 2 cm (¾ inch) long at one of the four uppermost |
| | nodes on the main stem with a fully developed leaf |
| R5 | Seed is 3 mm (⅛ inch) long in the pod at one of the four |
| | uppermost nodes on the main stem with a fully developed leaf |
| R6 | Pod containing a green seed that fills the pod cavity at one |
| | of the four uppermost nodes on the main stem with a fully |
| | developed leaf |
| R7 | One normal pod on the main stem that has reached its |
| | mature pod color |
| R8 | 95% of the pods have reached their mature pod color |

The instant invention calls for imparting two radiation wavelength distribution for receipt onto a seedling's leaves and other plant components. As will be discussed below, one preferred illumination embodiment calls for an Ultraviolet Illumination Distribution containing substantially wavelengths ranging from 280 to 400 nm, and also Medium Wavelength Infrared radiation substantially composed of 2 to 20 micron wavelength radiation, preferably 2 to 8 microns, and more preferably 2 to 5 microns.

Referring again to FIG. 7, the protocol is shown schematically, with Medium Wavelength Infrared MWIR (solid arrow line) and an Ultraviolet Illumination Distribution UVID (dotted arrow line) being directed to eligible young seedlings (ELIGIBLE PLANTS) which are in reproductive is growth stages and engaged in active photosynthesis (PLANT ELIGIBILITY). A range of SELECTED SOYBEAN GROWTH STAGES are shown at the bottom of the page (growth stages shown: VE, VC, V2, V4, R2, R5, R7, and R8), and as shown, eligible plants for this illustrative example range from VE to V4, which are non-reproductive.

The method for electrosignaling to obtain higher yield from a non-reproductive stage young plant seedling (PLANT) engaged in photosynthesis, comprises delivering to the young plant seedling an unnatural short time illumination signal by illuminating the young plant seedling with exposures to Medium Wavelength Infrared MWIR radiation, and also to an Ultraviolet Illumination Distribution UVID, with the illuminating precisely so formed and arrayed and timed to illuminate the seedling such that
[a] the Medium Wavelength Infrared radiation has a minimum average irradiance of 0.2 Watts/cm² and a maximum average irradiance of 1 Watts/cm²; and also has a minimum cumulative deposited energy of %2 Joule/cm² and a maximum cumulative deposited energy of 15 Joules/cm²; and
[b] the Ultraviolet Illumination Distribution has a minimum average irradiance of 0.01 Watt/cm² and a maximum average irradiance of 1 Watt/cm², and also has a minimum cumulative deposited energy of 0.2 Joule/cm² and a maximum cumulative deposited energy of 4 Joules/cm².

Optionally the Ultraviolet Illumination Distribution radiation can comprise any of UV-A, UV-B radiation and additionally indigo/violet radiation of wavelength 400-420 nm (as illustratively shown in the Figure with a origination baseline on the right side bottom of light spectrum) for a total possible wavelength range of 280 nm-420 nm. Alternatively, the Ultraviolet Illumination Distribution cam comprise relative peaks at about 315 nm and 370 nm wavelength. The administration of illumination for Medium Wavelength Infrared and an Ultraviolet Illumination Distribution can be simultaneous or not simultaneous, or partially simultaneous.

Now referring to FIG. 8, a preferred embodiment of a method is shown according to the invention with Medium Wavelength Infrared MWIR as taught and claimed impinging upon a soybean plant at a V2 vegetative stage, also receiving Ultraviolet Illumination Distribution UVID. The specificity of the deposited energy to certain (low) energies, namely % A to 15 Joules/cm² for Medium Wavelength Infrared, and 0.2 to 4 Joules/cm² for the Ultraviolet Illumination Distribution and yet needing a minimum average irradiance, namely 0.2 W/cm² for Medium Wavelength Infrared and 0.01 W/cm² for an Ultraviolet Illumination Distribution makes this phenomenon not obvious to try and hard to detect. The effect appears to vary somewhat by plant species and the particular plant growth stage selected for treatment. The two radiations as shown (MWIR and UVID) mandatory (MANDATORY DUAL IRRADIATION), meaning that either of Medium Wavelength Infrared and an Ultraviolet Illumination Distribution alone do not work, another unanticipated, hard to detect result.

Now referring to FIG. 9, hidden exposure parameters are shown that help define a short time illumination signal according to the invention. The exposures specified to practice the invention are defined by irradiance in W/cm² and also by cumulative deposited light energy in Joules/cm² separately for each of two mandatory irradiations, comprising Medium Wavelength Infrared radiation and also an Ultraviolet Illumination Distribution.

As stated above, the Medium Wavelength Infrared radiation impinging upon a PLANT seedling has a minimum average irradiance specified of 0.2 Watts/cm² and a maximum average irradiance of 1 Watts/cm²; and it also has a minimum cumulative deposited energy of ½ Joule/cm² and a maximum cumulative deposited energy of 15 Joules/cm².

Correspondingly, the Ultraviolet Illumination Distribution impinging upon a plant seedling has a minimum average irradiance of 0.01 Watt/cm² and a maximum average irradiance of 1 Watt/cm², and it also has a minimum cumulative deposited energy of 0.2 Joule/cm² and a maximum cumulative deposited energy of 4 Joules/cm².

For each of these radiations, the CUMULATIVE ACTIVE ILLUMINATION TIME in see (seconds) can be calcuated as follows:

$$Cumulative Active Illumination Time in seconds = Selected Cumulative Deposited Energy ( Joules / {cm}^{2} ) / Minimum Average Irradiance ( W / {cm}^{2} )$$

Example: for Medium Wavelength Infrared, a cumulative deposited energy of 3 Joules/cm² will be attained via a average irradiance of % W/cm² in 6 seconds net total exposure time.

The limit on the average irradiance for either Medium Wavelength Infrared or Ultraviolet Illumination Distribution of 1 W/cm² prevents damage or burning of leaf or other components.

Given the light exposure ranges above, preferred embodiments can be selected by those of ordinary skill following the instant teachings. For example, regarding Medium Wavelength Infrared, the minimum average irradiance to engage is 0.2 W/cm², and preferred minimum average irradiances can be selected from any value in this state range, such as 0.3 W/cm², 0.4 W/cm², 0.5 W/cm², 0.6 W/cm², 0.7 W/cm², 0.8 W/cm², 0.9 W/cm², and 1.0 W/cm². In a similar manner, regarding an Ultraviolet Illumination Distribution the minimum average irradiance to engage is 0.01 W/cm², and preferred minimum average irradiances can be selected from any value in this state range, such as 0.05 W/cm², 0.1 W/cm², 0.2 W/cm², 0.3 W/cm², 0.4 W/cm², 0.5 W/cm², 0.6 W/cm², 0.7 W/cm², 0.8 W/cm², 0.9 W/cm², and 1.0 W/cm². Similar preferred ranges for these variables can be selected as maximums, such as ½ W/cm² average irradiance for either the Medium Wavelength Infrared or an Ultraviolet Illumination Distribution to practice the invention.

The methods and protocols given herein to practice the instant invention are governed by meanings given in the Definitions Section.

Now referring to FIG. 10, a schematic representation is shown of action that results from electrosignaling of a plant. As shown, PLANT ELECTROSIGNALING as taught and claimed herein causes a later, previously unknown and non-obvious LATER INNATE RESPONSE to arise in a young plant seedling, allowing obtaining of a INCREASED YIELD.

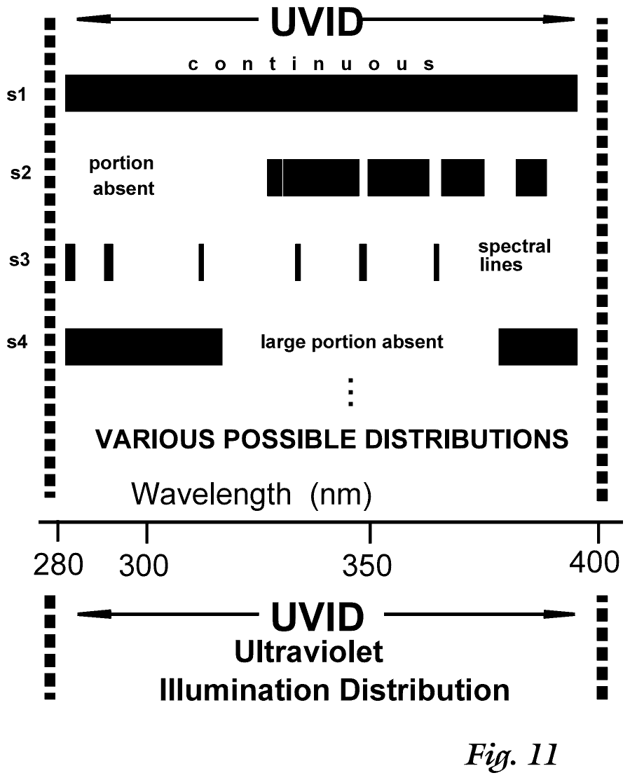

Now referring to FIG. 11, a schematic representation across a range of 280 nm to 400 nm for an Ultraviolet Illumination Distribution is shown with various illustrative possible distribution patterns that are possible. This Figure does not show spectral intensity, or spectral irradiance, that is, W/cm² per unit wavelength—which can vary. The Figure shows only the presence of radiation in particular wavelength, without intensity information.

The first distribution depicted, s1, shows a near full span of the range between 280 and 400 nm, continuous and solid. The second distribution s2 shows another possible distribution from 300 to 400 nn, not continuous and absent UV-B radiation. A third distribution s3 shows various spectral lines of output, with the highest energy radiation at about 370 nm, and consisting of only six emission lines as shown. This can arise from various light sources, such as lasers, and especially ion discharge lamps with no intervening phosphor. A fourth distribution s4 is continuous in part like distribution s1, but is absent mid-wavelengths. All these, and other distributions are possible as preferred embodiments in service of the instant invention.

Appearance of the Ultraviolet Illumination Distribution UVID to the human eye shall not be is indicative of suitability, An Ultraviolet Illumination Distribution may not happen to appear in any particular way, e.g., appearing “violet” to the human eye because of the effect of constituent wavelength components—and response of the human eye to light distributions, including known effects of metamerism, shall not limit or narrow the scope of the appended claims, nor narrow the instant teachings. In the protocol taught and claimed in the instant disclosure, the preferred range of wavelengths for the Ultraviolet Illumination Distribution is 280-400 nm.

Known commercially available high output UV or Ultraviolet LEDs (light emitting diodes) can be used to provide necessary light for Ultraviolet Illumination Distribution UVID, providing light generally in a preferred wavelength range from 350 to 400 nm. LED devices using Aluminium Gallium Nitride (AlGaN) produce ultraviolet (UV-A) light, and known phosphors can be used or added by those of ordinary skill in the art to extend spectral range or to serve another objective such as making a trademark color splash without departing from the scope of the invention and appended claims.

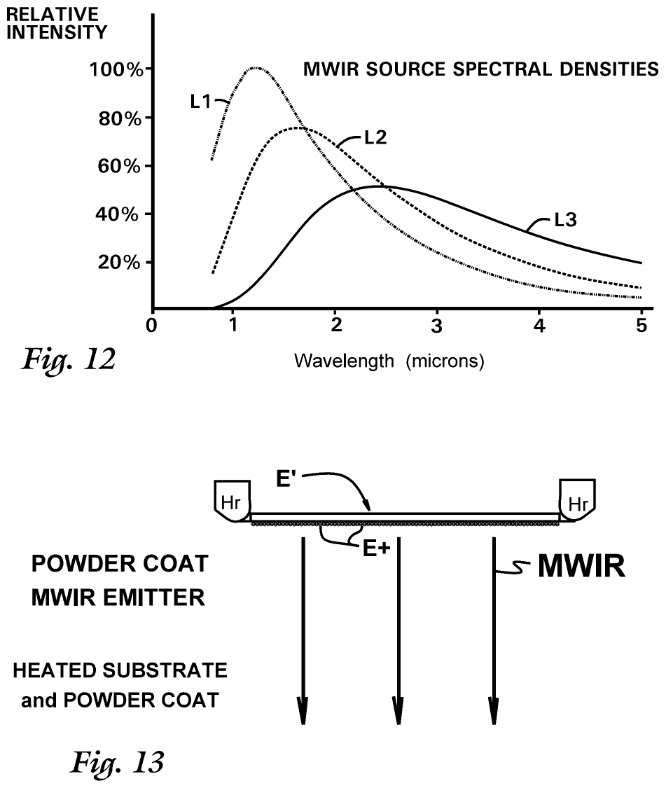

Now referring to FIG. 12, three illustrative cartesian plots of spectral density versus wavelength for three possible Medium Wavelength Infrared light sources for use by the instant invention are shown. In the instant teachings, the wavelength of any MWIR emitter figures importantly, with a wavelength of 2-8 microns preferred, including 2-5 microns.

Known and commercially available tubular lamps can provide Medium Wavelength Infrared radiation in service of the instant invention, or provide thermal excitation to produce such radiation. The three spectral plots shown represent three different tubular lamps:

L1 depicts a spectral density for a clear halogen lamp with a pyrex outer jacket, operating temperature 2400K, with a peak output wavelength of 1.3 microns. This lamp is preferred to obtain high radiation output because of its high operating temperature, and the output can be used to excite borosilicate glass in proximity, as known by those of ordinary skill in the art of lamp design and heat sources.

L2 depicts a ruby/gold-plated halogen lamp spectral density for a clear halogen lamp with a pyrex outer jacket, operating temperature 1800 K, with a peak output wavelength of 1.6 microns.

L3 depicts a spectral density for a clear halogen lamp with a carbon fiber filament and a quartz outer jacket, operating temperature 1200 K, with a peak output wavelength of 2.5 microns. This lamp is preferred when using as a direct light source to practice the instant is invention, because the substantial share of the radiation output is at the preferred range of 2-8 microns.

These above lamps (not shown) are standard configurations and available from Lianyungang O-Yate Lighting Electrical Co., Ltd, Lianyungang City, Jiangsu Province, China.

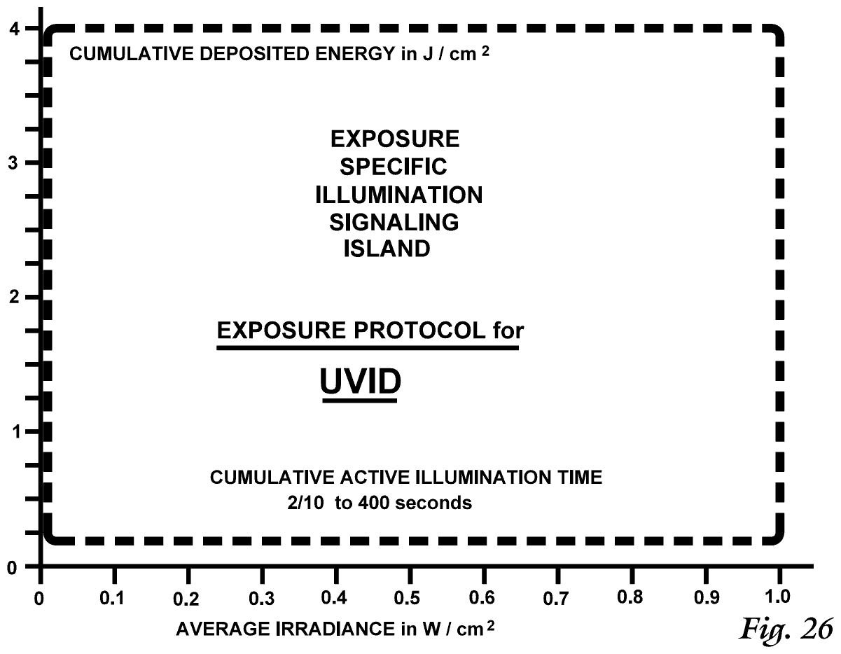

FIG. 13 shows a cross-sectional schematic view of a Medium Wavelength Infrared (MWIR) emitter that comprises an emissive powder coat for enhanced emission. A powder coat MWIR emitter, e.g., ground or powdered borosilicate glass, can be put onto a surface which is heated for operation according to the invention. Specifically, as shown, powder coat MWIR emitter E+ is affixed or coated upon a heated substrate E′, which can derive heat from heat ring Hr or the above tubular lamps alluded to above in the description for FIG. 26. Rays from any Ultraviolet Illumination Distribution UVID passing though powder coat MWIR emitter E+ are not shown for clarity. This embodiment can reduce costs and weight, and can allow for optimization of output. This allows the powder coat to be illuminated independently to provide heating. This excitation can include optical radiation (in a variety of possible wavelengths) such as from lamps; glowing filaments or other bodies, microwave radiation, laser light, and flood and spot lamps, such as high intensity halogen enhance filament lamps, or LED lamps, using known reflector or other optics. Arrays can be used that are proximate the powder coat MWIR emitter E+ along a length, or a spot beam can be used. In this illustrative example, a simple substrate E′ which is not an Medium Wavelength Infrared emitter, can be used.

One can use known powdered, sintered, or particulate materials, comprising borosilicate glass or other glasses or MWIR emissive materials, to provide the main radiation source that establishes the specific Medium Wavelength Infrared MWIR called for in service of the invention as taught and claimed. If desired, underlying heated substrate E′ can itself be a MWIR emitter E as well. In addition, MWIR emitter E+ can be externally optically energized from a distance—or heated with an external lamp or source (not shown) as those of ordinary skill in the art can appreciate.

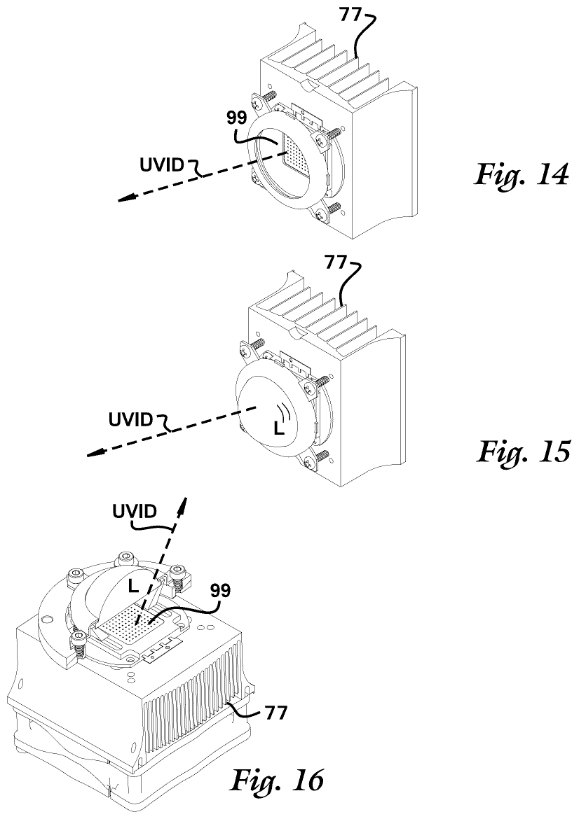

Now referring to FIGS. 14, 15 and 16, oblique surface views of various LED driven ultraviolet light sources are shown that can be employed in service of the instant invention.

UVID emitter 99 is serviced thermally by heat sink 77, with Ultraviolet Illumination Distribution UVID emerging from a LED chipset as shown. FIG. 15 shows additionally a lens L covering the chipset and allowing passage of Ultraviolet Illumination Distribution light therethrough. Lens L can optionally focus the Ultraviolet Illumination Distribution light and also optionally can be heated (heaters not shown) to produce some Medium Wavelength Infrared radiation also. A cutout view of the Lens L is shown in FIG. 16.

To construct an Ultraviolet Illumination Distribution UVID source, commercially available high power UV/violet LED chips are thus available in varied peak distribution wavelengths such as 365 nm, 370 nm, 375 nm, 385 nm, 390 nm 395 nm, 400 nm, 405 nm, and 425 nm with input power ranging from 3 to 100 watts, such as available from Shenzhen Chanzon Technology Co., Ltd., ShenZhen, Guangdong, China. The embodiments shown in Figures can employ a 100 watt array. Larger arrays can be built up from constituent chips to serve the requirements of the instant invention for larger scale applications. In particular, a Chanzon SMD C08 High Power LED chip 100 watt purple ultraviolet light source produces a peak radiation of UV/Ultraviolet at wavelength 395 nm, drawing 3000 mA from a DC voltage of 30V-34V.

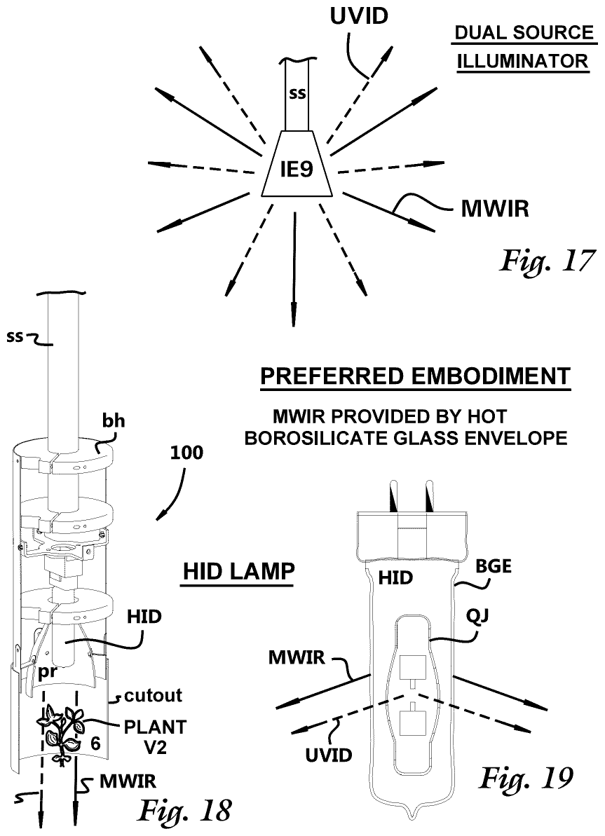

Now referring to FIGS. 17, 18 and 19, a schematic view, cutout oblique view, and a combination cross-sectional and surface view, respectively, of illustrative dual source consolidated light sources as preferred embodiments to practice the instant invention are shown. FIG. 17 shows illuminator IE9 attached to a support shaft ss as shown, and emitting both Medium Wavelength Infrared and Ultraviolet Illumination Distribution light.

FIG. 18 shows a cutout oblique view of a handheld illumination assembly 100 which comprises support shaft ss supporting a series of three bulkheads bh that frame out an aluminum cylindrical housing 6 that is cut out (see cutout) in the Figure. One bulkhead supports a parabolic reflector pr as shown which in turn focusingly couples to a high intensity discharge lamp HID as shown. The handheld illumination assembly 100 can be energized and positioned over a young plant seedling (PLANT) and Ultraviolet Illumination Distribution UVID and Medium Wavelength Infrared MWIR from high intensity discharge lamp HID emerge as shown to irradiate the seedling as taught and claimed herein.

FIG. 19 shows a combination cross-sectional and surface view, of the high intensity discharge lamp HID of FIG. 18. The HID lamp contains an active inner portion surrounded by a borosilicate glass envelope BGE as shown. The active portion of the HID lamp contains known components such as two electrodes between which an arc (not labeled or explicitly shown) is struck and maintained. Intense ultraviolet Illumination Distribution radiation which is generated from this arc passes through a quartz jacket QJ and emerges from the borosilicate is glass envelope BGE. The proximity to the intense discharge or arc inside the quartz jacket QJ causes the borosilicate glass envelope BGE to rise in temperature to 400 F, 500 F, or 600 F or more, making it a potent producer of Medium Wavelength Infrared radiation, in service to practicing the invention.

Borosilicate glass and other similar materials conduct heat across themselves, and this heated glass allows efficient production and coupling into MWIR wavelengths and allows a pass-through of Ultraviolet Illumination Distribution UVID light as shown.

This preferred embodiment can be provided via use of a known metal halide lamps such as Philips Broadway Metal Halide lamp, model MSR 400, with a GX9.5 base, part number 9280 779 05115, distributed by Philips Lighting Company, Somerset, NJ 08873-6800, a division of Philips Electronics Corp., North America. The MSR designation signifies “Medium Source Rare-Earth” which describes a medium arc length metal halide arc lamp using dysprosium iodide as the halide fill. These are all double-ended discharge tubes mounted in single-ended envelopes and bases. The lamp input is 400 watts, with a nominal initial output of 32,000 lumens. With the borosilicate glass envelope BGE as part of this lamp, a spectral output arises with a color rendition index of 95 and a range of wavelengths from UV-B to Medium Wavelength Infrared, making it a useful dual source unitary illuminator. Support shaft ss can be in fluid and electrical communication with a support module (not shown) which can house or accommodate a cooling fan to force cooling air through the handheld illumination assembly 100 for long operation, and can also comprise any needed traditional or electronic ballast for protection of the metal halide arc lamp components, and to assure precise radiation exposures to seedlings as taught anc claimed.

Whenever a high intensity discharge lamp HID is used to provide an Ultraviolet Illumination Distribution, and the said Medium Wavelength Infrared radiation can be provided at least in part by any of borosilicate glass, soda lime glass, silica fusion glass, and aluminum oxide ceramic in thermal communication with at least part of the high intensity discharge lamp.

### Exposures Using the Handheld Illumination Assembly 100

The broad approximate Medium Wavelength Infrared output from the handheld illumination assembly 100 was 0.4 W/cm², so that a 10 second exposure would impart about 4 Joules/cm² to the seedling(s).

Because of geometric and reflector differences in prototypes, the broad approximate Ultraviolet Illumination Distribution output from the handheld illumination assembly 100 was 140 to 332 mW/cm², so that a 10 second exposure would impart about 1.4 Joules/cm² to 3.32 Joules/cm²s to the seedling(s), depending on the particular illumination assembly used.

### UNANTICIPATED REQUIREMENTS for EXPOSURES

It is important to note that if one uses an ordinary lamp that does not have an appreciable Medium Wavelength Infrared output component, such as a quartz-jacketed halogen lamp, then experiments and trials to verify the effect that forms the discovery of the instant invention will fail. This was unanticipated, and was not predicted by prior art. Quartz is not a sufficient source of MWIR to produce the hidden exposure effect. A substantial Medium Wavelength Infrared lamp output component is necessary to practice the invention, as well as an Ultraviolet Illumination Distribution, as specified in the appended claims.

Trials also bore out that administration of blue light and MWIR also did not work.

Furthermore, trials also revealed In addition that exposure of eligible young seedlings to only UV-A and UV-B does not work, and furthermore that absence of UV-A and UV-B means it will not work, e.g., Chanzon light emitting diodes (LEDs) with 440 nm peaks supplemented by carbon element heaters without MWIR output enhancement did not work.

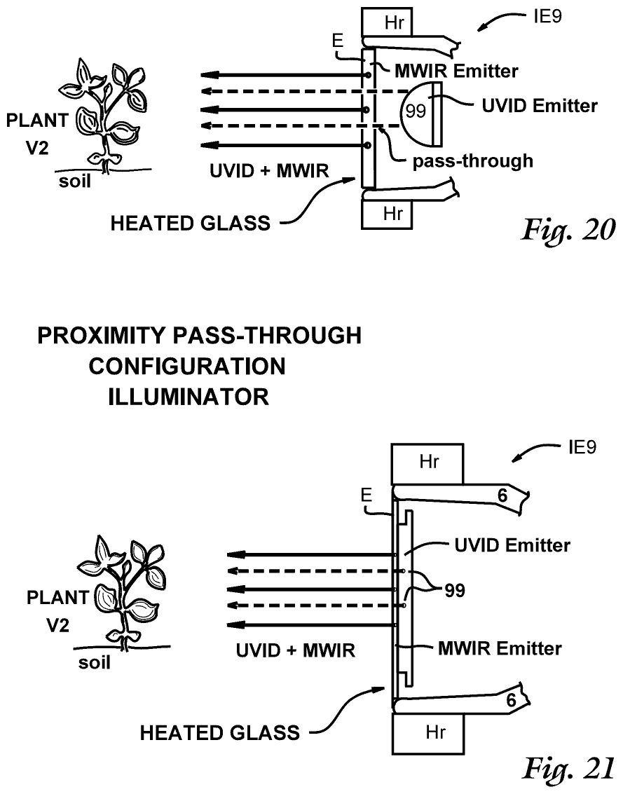

Now referring to FIGS. 20 and 21, simple schematic cross-sectional representations of an illustrative illuminator IE9, specifically an advantageous, compact proximity pass-through configuration illuminator (PROXIMITY PASS-THROUGH CONFIGURATION ILLUMINATOR) according to the invention, is shown. Inside a housing 6, are an UVID emitter 99 and a MWIR emitter E. As can be seen, the UVID emitter and the MWIR emitter are sized, positioned and oriented to allow light output from each of said UVID emitter and MWIR emitter to be substantially superposed for directing to a seedling (PLANT) with rays being directed to the seedling at the left of the Figure. Light generated as shown emerging from UVID emitter 99 passes through the physical MWIR emitter E. MWIR emitter E can comprise glass in various forms, such as plate glass, and be can be any of borosilicate glass, Pyrex® Glass Code 7740, soda lime glass, and other materials like aluminum oxide ceramic, and any such material having high thermal emissivity in the range of Medium Wavelength Infrared wavelengths as defined herein. This can include materials having coatings or surface treatments that have favorable MWIR emission characteristics.

Illustrative MWIR emitter E is heated using a heater assisted by a heating ring Hr as shown, in thermal communication with illustrative glass (e.g., borosilicate glass) of MWIR emitter E. Borosilicate glass and other similar materials conduct heat across themselves, and this heated glass allows efficient coupling into MWIR wavelengths and allows a pass-through of Ultraviolet Illumination Distribution UVID light as shown.

An alternative to heating a preferred borosilicate glass MWIR emitter E using a heating ring Hr is the use of heat sources in the form of commercially available known tubular lamps, and illustrative spectral densities for these are given above in the Description for FIG. 12.

### TRIALS AND TESTS on SOYBEANS

TEST A—Multi-year tests on soybeans gave results which were marked.

In a test plot on a farm field in Oberlin OH, 728 plants along with a control group were tested. Seedling growth stages ranged from VC to V3 stage. Illumination was provided by the HANDHELD ILLUMINATION ASSEMBLY 100 energized as described above:

| | | |
|---|---|---|
| TREATMENT TIME (sec) | Dry Weight (g) | GAIN (percent) |

Dry Weight Test

| | | |
|---|---|---|
| 0 | 477 | 0 |
| 2 | 506 | 6.0% |
| 5 | 516 | 8.1% |
| 10 | 585 | 22.6% |

Pods/plant Test

| | | |
|---|---|---|
| 0 | 41.6 | 0% |
| 2 | 43.3 | 4.1% |
| 5 | 45.8 | 10.1% |
| 10 | 51.0 | 22.6% |

TEST B—In another study in a farm field in Oberlin OH, VC to V3 stage seedlings were tested, using side illumination at a 45 degree angle with respect to vertical, using the HANDHELD ILLUMINATION ASSEMBLY 100 energized as described.

Plant side illumination with a treatment time of 5 seconds yielded a 4.9% increase in beans per plant, while a 10 second exposure yielded a 9.4% increase in beans per plant.

TEST C—In a test on seedlings in V2-V3 growth stages, an untreated control group had 2.4 flowers per plant. After a 10 second treatment using the handheld illumination assembly 100 energized as described according to the invention, the seedlings yielded 9.5 flowers per plant, a 6.6 percent increase in the number of seed pods/plant, and also manifesting a 23.2 percent increase in beans per plant.

### SUMMARY of MULTI-YEAR FIELD TRIALS

Exposure Time in seconds with handheld illumination assembly 100 energized as described, according to the invention:

| | 0 | 2 | 5 | 10 | 15 | 20 | 25 |
|---|---|---|---|---|---|---|---|
| | Seed Pods per Plant | | | | | | |
| Top illumination | 37.2 | 42.4 | 40.3 | 41.8 | — | — | — |
| Side 45° illumination | 39.9 | — | 36.8 | 44.1 | 46 | 43 | 41.5 |

Note that efficacity drops for higher (longer) illumination exposures. This is a phenomenon that hides from detection by those illuminating for high cumulative deposited energies, such as when supplementing light in a growhouse. Different results were obtained depending on seedling growth stage, and those of ordinary skill will be able to judge what is best for each plant species for initiation time for the illumination signal as taught and claimed.

### Canola

Stimulating eligible soybean seedlings plants by using the method of the instant invention and applying 5-10 seconds of energy to the plants at V1-V2 stage by use of the handheld illumination assembly 100 described above (see FIG. 18), resulted in increased yields by as much as 20 percent.

Similar exposures on alfalfa seedlings resulted in increased the quantity of leaves on using just a 5-10 second application if the alfalfa plant is exposed at an early vegetation stage.

In tests on canola, a plant growth chamber was used containing 36 cm (14 inch) diameter, 30 cm (12 inch) deep plant pots filled with organic potting mix. Some sand was added to the top 2.5 cm (1 inch) of soil. Canola seeds were planted and were allowed to germinate and grow to the 2-leaf stage (non-reproductive stage). The handheld illumination assembly 100 of FIG. 19 was held above the canola seedlings, about 10 cm (4 inches) above the soil and over the seedling plant to be stimulated. After six weeks of further growth, the plant height and above-ground biomass were assessed.

The results included height of the treated canola was 2.5-5 cm (1-2 inches) taller. The diameter of stalks appeared larger in the illuminated canola, while there appeared to be more leaf stem branches in the control group of plants not receiving illumination according to the invention.

### Mango Trees

In another trial 30 cm tall (one foot tall) mango seedlings were exposed to the handheld illumination assembly 100 bathing the seedlings up and down in light according to the invention and a week later, the illuminated trees were unexpectedly larger than the other 3 trees which had no light exposure.

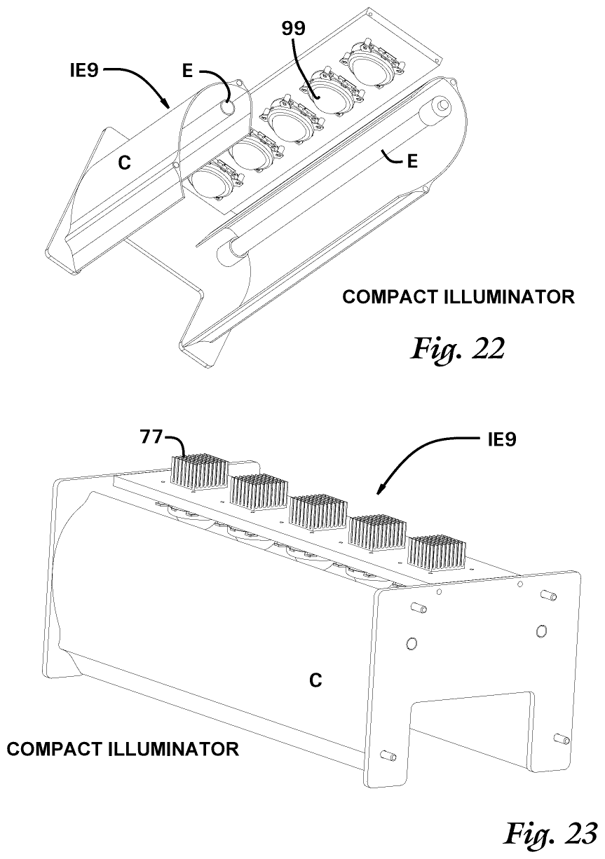

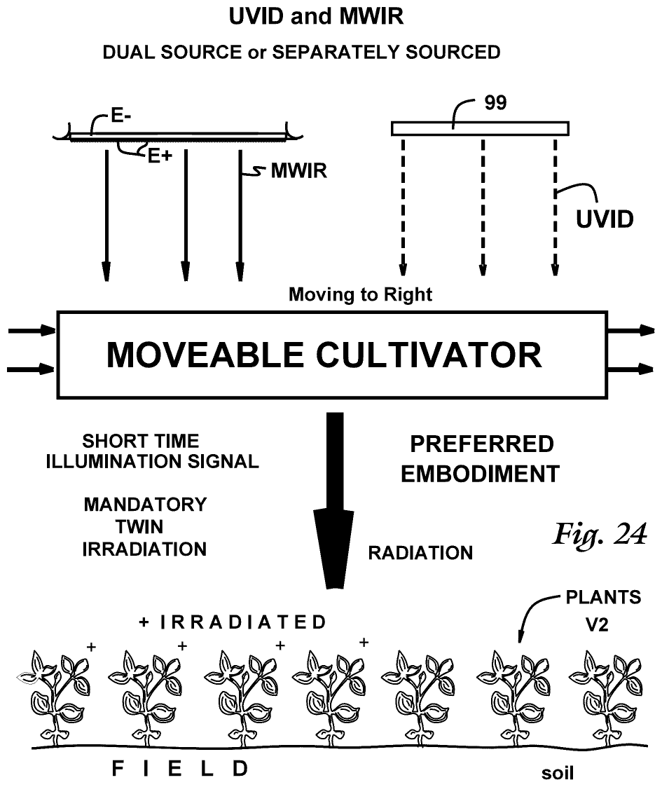

Now referring to FIGS. 22 and 23, oblique surface views of the compact illuminator in service of the instant invention are shown. A central assembly (not labeled) houses a plurality of UVID emitters 99 that are positioned in between pipe-like MWIR emitters E, whose emitted infrared radiation is reflected by curved reflector housing C as shown. UVID emitter 99 are serviced by heat sinks 77 as shown, and can be 100 watt array, 395 nm peak output LED arrays. This compact illuminator can be used to illuminate, either directly or indirectly plant seedlings as taught and claimed, including in service to the embodiment discussed below and depicted in FIG. 24.

The interiors (not explicitly shown) of MWIR emitters E can comprise heaters; or tubular lamps as previously described, such as a clear halogen heat lamp, which essentially acts as a cartridge heater with a glass or quartz exterior. Alternatively, a preferred embodiment can comprise the tubular MWIR emitters E as shown with an emissive coating, such as a known aluminum oxide ceramic, or MWIR emitters E can comprise copper pipes sprayed with glass, or with aluminum oxide thermal spray. Any high emissivity coating on a thermally heated tube could offer advantages so long as the emissions are as called for in the protocol for the is invention, preferably Medium Wavelength Infrared in the range of 2 to 8 micron wavelengths.

Growth of large farms has lead to utilizing precise seeding intervals in rows, typically 30 inches apart, with subsequent farming operations often using advanced mechanized farm implements, often pulled by tractors. It is possible to use the teachings of the instant invention to impart electrosignaling according to the invention to multiple plants in rows, or even to change young seedlings in a field. The compact illuminators of FIGS. 22 and 23, or other illuminators, can be used for that purpose.

Now referring to FIG. 24, a schematic depicting MWIR and UVID sources to illuminate young seedlings in a field using a moveable cultivator according one preferred embodiment of the invention is shown.

Illustratively shown powder coat MWIR emitter E+ and LED array/UVID emitter 99 can be separately housed as shown, or can be unitary, such as shown in FIGS. 17-19. Optional guide optics (not shown) can be provided by those skilled in the art using known reflectors, transmitters, light guides, refractors, etc. to direct Medium Wavelength Infrared MWIR and Ultraviolet Illumination Distribution UVID as taught and claimed. This light for applied exposure according to the invention is a feature installed upon a schematically shown MOVEABLE CULTIVATOR. The moveable cultivator or illuminated moveable cultivator with dual source illuminator or separately sourced Medium Wavelength Infrared and Ultraviolet Illumination Distribution illuminators can be installed upon equipment that can comprise any vehicle, cart, cultivator implement, machinery, wagon, housing or moving frame, whether self-powered, externally powered, self-propelled, or drawn by other equipment as known in the agricultural arts, and regardless of whether or not it is expressly or implicitly rededicated from another purpose.

This MOVEABLE CULTIVATOR can provide electrosignaling to obtain higher yield from non-reproductive stage young plant seedlings engaged in photosynthesis. The moveable cultivator can comprise an illuminator (IE9 such as described in FIGS. 17-19, or the MWIR emitter E/E′+E+ as shown in the Figure, combined into the thick arrow labeled RADIATION). Those skilled in the art can form, array, locate, position, operate and energize the illuminator to deliver to the young plant seedlings an unnatural short time illumination signal by illuminating the young plant seedlings with exposures to Medium Wavelength Infrared (MWIR) radiation, and also to an Ultraviolet Illumination Distribution (UVID, and the moveable cultivator can be formed, moved and energized to move along a field (F I E L D) comprising the young plant seedlings, such that the illuminator can move and illuminate precisely the young plant seedlings with
[a] Medium Wavelength Infrared radiation having a minimum average irradiance of 0.2 Watt/cm² and a maximum average irradiance of 1 Watt/cm²; and also having a minimum cumulative deposited energy of ½ Joule/cm² and a maximum cumulative deposited energy of Joules/cm²; and also illuminate precisely the young plant seedlings with
[b] an Ultraviolet Illumination Distribution having a minimum average irradiance of 0.01 Watt/cm² and a maximum average irradiance of 1 Watt/cm², and also having a minimum cumulative deposited energy of 0.2 Joule/cm² and a maximum cumulative deposited energy of 4 Joules/cm². As shown in the Figure, young seedling PLANTS, illustratively shown in vegetative stage V2, are irradiated sequentially as visited by the moveable cultivator (shown+I R R A D I A T E D) as the moveable cultivator moves down the field

This allows mass treatment of young seedlings in a field or agricultural field using the same illumination protocol described above and in the appended claims. After this electrosignaling via a short illumination signal delivered to the field, treated seedlings in the field are different in that they will have a higher yield in terms of flowers, blossoms, or crop yield. This changes the nature of the field agriculturally, as a whole.

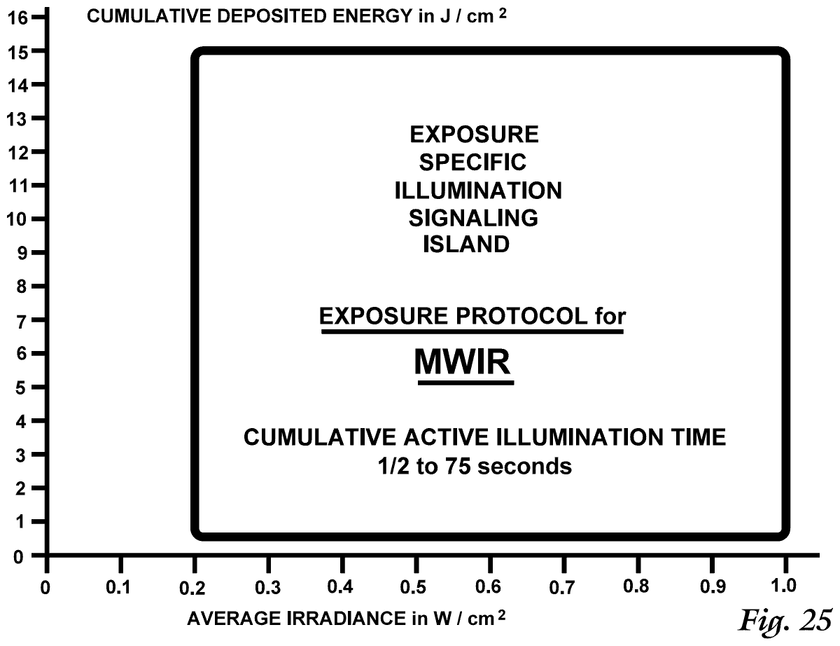

Now referring to FIG. 25, an exposure protocol for Medium Wavelength Infrared radiation MWIR according to the invention is shown, by depicting an Exposure Specific Illumination Signaling island, on a cartesian plot of Cumulative Deposited Energy versus Average Irradiance. This Exposure-Specific Illumination Signaling Island contains within its perimeter as shown, all allowable Average Irradiance values in W/cm² and all allowable Cumulative Deposited Energy values in Joules/cm²—for exposures that can have a duration or CUMULATIVE ACTIVE ILLUMINATION TIME ranging from 2 to 75 seconds. In practicing the instant invention, one is free to select values for Medium Wavelength Infrared radiation inside this island. As specified in the appended claims, the average irradiance of MWIR can range from 0.2 W/cm² to 1.0 W/cm², while the cumulative deposited energy can range from ½ Joules/cm² to 15 Joules/cm².

Similarly, and now referring to FIG. 26, an exposure protocol for an Ultraviolet Illumination Distribution UVID according to the invention is shown, by depicting an Exposure Specific Illumination Signaling island, on a similar cartesian plot of Cumulative Deposited Energy versus is Average Irradiance. This Exposure-Specific Illumination Signaling Island contains within its perimeter as shown, all allowable Average Irradiance values in W/cm² and all allowable Cumulative Deposited Energy values in Joules/cm²—for exposures that can have a duration or CUMULATIVE ACTIVE ILLUMINATION TIME ranging from 0.2 to 400 seconds. In practicing the instant invention, one is free to select values for an Ultraviolet Illumination Distribution inside this island. As specified in the appended claims, the average irradiance of UVID can range from 0.01 W/cm² to 1.0 W/cm², while the cumulative deposited energy can range from 0.2 Joules/cm² to 15 Joules/cm².

The partial illumination of seedlings at various points, step by step, can read on the invention as claimed as long as the minimum average irradiance and maximum average irradiance as taught and claimed in the instant disclosure are met, and as long as the narrow specific range of cumulative deposited illumination energy in Joules/cm² is followed. Those of ordinary skill can devise, using the teachings herein, multiple illuminations provided at various points that meet the average irradiance and cumulative illumination energy requirements as taught and claimed without departing from the scope of the claims. For example, a plurality of light sources can be chosen and sized and arrayed and operated and added together to provide a time average irradiance of 0.2 Watts/cm² of Medium Wavelength Infrared MWIR to seedlings.

In practicing the invention, one can use intermittent sources, a flash or flashes, without departing from the scope of the appended claims.

Generally, regarding exposures as taught and claimed herein, there are many possible factors which would require a practitioner of the method of the invention to change exposures, such as the varied effectiveness of the invention on many varied different plant species; plant environmental history, prior sun exposure, history of rain or water uptake, miscellaneous species factors; plant condition; and soil factors. So those skilled in the agricultural arts will realize that specific exposures within the scope of the appended claims can be adjusted to optimize results.

Multiple applications of the instant invention, such as lower dose applications can be contemplated whereby improved germination viability, increased root mass and crop yield can increase with multiple applications, subject to the appended claims.

The invention can use autonomous, non-autonomous, powered, or non-powered vehicles to illuminate or treat a field, using illumination as taught and claimed, or notably, using communication to other, external light sources. The invention can also be combined with other processes, including transport, cleaning, tilling, planting and sorting processes not mentioned in this disclosure without departing from the appended claims.

Known imaging optics can be added to practice the protocol of the invention, including beam forming using parabolic curved sections, or sections that resemble a compound parabolic curve; and non-imaging optics can also be used. If desired, one can redirect all electromagnetic emissions as taught and claimed in the instant disclosure using mirrors, lenses, foil arrays, or light guides and pipes without departing from the scope of the invention. Similarly, those of ordinary skill can add light wavelengths to the exposure protocols without departing from the invention or the appended claims.

Measurement units were chosen illustratively and in the appended claims include irradiance in W/cm² but radiance or other similar measures can be used and would by fair conversion read upon the appended claims if equivalent.

For clarity, the invention has been described in structural and functional terms. Those reading the appended claims will appreciate that those skilled in the art can formulate, based on the teachings herein, embodiments not specifically presented here without departure from the claims. Modifications can be made to the illumination as taught and claimed here without departing from the scope of the appended claims, such as gradually ramping up irradiances to claimed values for operating safety or to prolong the life of lamps and equipment.

Production, whether intentional or not, of irradiance levels that are under the magnitude of powers as given in the appended claims shall not be considered a departure from the claims if a power level as claimed is used at any time during treatment.

The illumination protocol disclosed and claimed can be supplemented with visible light, which can enhance user safety by increasing avoidance and can allow for pupil contraction of the eye of an operator; other radiations can be added with without departing from the appended claims.

There is obviously much freedom to exercise the elements or steps of the invention.

The description is given here to enable those of ordinary skill in the art to practice the invention. Many configurations are possible using the instant teachings, and the configurations and arrangements given here are only illustrative.

Those with ordinary skill in the art will, based on these teachings, be able to modify the invention as shown.

The invention as disclosed using the above examples may be practiced using only some is of the optional features mentioned above. Also, nothing as taught and claimed here shall preclude addition of other structures, functional elements, or systems.

Obviously, many modifications and variations of the present invention are possible in light of the above teaching. It is therefore to be understood that, within the scope of the appended claims, the invention may be practiced otherwise than as specifically described or suggested here.

We claim:

1. A method for electrosignaling to obtain higher yield from a non-reproductive stage young plant seedling (PLANT) engaged in photosynthesis, said method comprising:
delivering to said young plant seedling an unnatural short time illumination signal by illuminating said young plant seedling with exposures to Medium Wavelength Infrared MWIR radiation, and also to an Ultraviolet Illumination Distribution UVID;
said illuminating precisely so formed and arrayed and timed to illuminate said seedling such that
[a] said Medium Wavelength Infrared radiation has a minimum average irradiance of 0.2 Watt/cm² and a maximum average irradiance of 1 Watt/cm²; and also has a minimum cumulative deposited energy of % A Joule/cm² and a maximum cumulative deposited energy of 15 Joules/cm²; and
[b] said Ultraviolet Illumination Distribution has a minimum average irradiance of 0.01 Watt/cm² and a maximum average irradiance of 1 Watt/cm², and also has a minimum cumulative is deposited energy of 0.2 Joule/cm² and a maximum cumulative deposited energy of 4 Joules/cm².

2. The method for electrosignaling of claim 1, wherein said Ultraviolet Illumination Distribution radiation comprises any of UV-A, UV-B radiation and indigo/violet radiation of wavelength 400-420 nm, for a total possible wavelength range of 280 nm-420 nm.

3. The method for electrosignaling of claim 1, wherein said Ultraviolet Illumination Distribution comprises relative peaks at about 315 nm and 370 nm wavelength.

4. The method for electrosignaling of claim 1, wherein a high intensity discharge lamp HID is used to provide said Ultraviolet Illumination Distribution, and said Medium Wavelength Infrared radiation is provided at least in part by any of borosilicate glass, soda lime glass, silica fusion glass, and aluminum oxide ceramic in thermal communication with at least part of said high intensity discharge lamp.

5. The method for electrosignaling of claim 1, wherein said illuminating originates from, and moves with a moveable cultivator that moves along a field.

6. The method for electrosignaling of claim 1, wherein said exposures of said Medium Wavelength Infrared and said Ultraviolet Illumination Distribution occur at least in part non-simultaneously.

7. A moveable cultivator (MOVEABLE CULTIVATOR) to provide electrosignaling to obtain higher yield from non-reproductive stage young plant seedlings (PLANT) engaged in photosynthesis, said moveable cultivator comprising:
an illuminator (IE9) so formed, arrayed, located, positioned, operated and energized to deliver to said young plant seedlings an unnatural short time illumination signal by illuminating said young plant seedlings with exposures to Medium Wavelength Infrared (MWIR) radiation, and also to an Ultraviolet Illumination Distribution (UVID); said moveable cultivator so formed, moved and energized to move along a field comprising said young plant seedlings, such that said illuminator can move and illuminate precisely the young plant seedlings with
[a] Medium Wavelength Infrared radiation having a minimum average irradiance of 0.2 Watt/cm² and a maximum average irradiance of 1 Watt/cm²; and also having a minimum cumulative deposited energy of ½ Joule/cm² and a maximum cumulative deposited energy of Joules/cm²; and also illuminate precisely the young plant seedlings with an
[b] Ultraviolet Illumination Distribution having a minimum average irradiance of 0.01 Watt/cm² and a maximum average irradiance of 1 Watt/cm², and also having a minimum cumulative deposited energy of 0.2 Joule/cm² and a maximum cumulative deposited energy of 4 Joules/cm².

8. The moveable cultivator of claim 7, wherein said Ultraviolet Illumination Distribution radiation comprises any of UV-A, UV-B radiation and indigo/violet radiation of wavelength 400-420 nm, for a total possible wavelength range of 280 nm-420 nm.

9. The moveable cultivator of claim 7, wherein said Ultraviolet Illumination Distribution comprises relative peaks at about 315 nm and 370 nm.

10. The moveable cultivator of claim 7, wherein a high intensity discharge lamp HID is used to provide said Ultraviolet Illumination Distribution, and said Medium Wavelength Infrared radiation is provided at least in part by any of borosilicate glass, soda lime glass, silica fusion glass, and aluminum oxide ceramic in thermal communication with at least part of said high intensity discharge lamp.

11. The moveable cultivator of claim 7, wherein said exposures of said Medium Wavelength Infrared and said Ultraviolet Illumination Distribution occur at least in part non-simultaneously.

12. An agricultural field, comprising:
a field (FIELD) comprising non-reproductive stage young plant seedlings (PLANT) engaged in photosynthesis that have undergone electrosignaling to obtain higher yield wherein said young plant seedlings have received an unnatural short time illumination signal comprising illumination exposures to Medium Wavelength Infrared MWIR radiation, and also to an Ultraviolet Illumination Distribution UVID; said illumination exposures precisely so formed and arrayed and timed to have illuminated said seedlings such that
[a] said Medium Wavelength Infrared radiation had a minimum average irradiance of 0.2 Watt/cm² and a maximum average irradiance of 1 Watt/cm²; and also had a minimum cumulative deposited energy of % A Joule/cm² and a maximum cumulative deposited energy of 15 Joules/cm²; and
[b] said Ultraviolet Illumination Distribution had a minimum average irradiance of 0.01 Watt/cm² and a maximum average irradiance of 1 Watt/cm², and also had a minimum cumulative deposited energy of 0.2 Joule/cm² and a maximum cumulative deposited energy of 4 Joules/cm².

13. The agricultural field of claim 12, wherein said Ultraviolet Illumination Distribution radiation comprises any of UV-A, UV-B radiation and indigo/violet radiation of wavelength 400-420 nm, for a total possible wavelength range of 280 nm-420 nm.

14. The agricultural field of claim 12, wherein said Ultraviolet Illumination Distribution comprises relative peaks at about 315 nm and 370 nm.

15. The agricultural field of claim 12, wherein a high intensity discharge lamp HID is used to provide said Ultraviolet Illumination Distribution, and said Medium Wavelength Infrared radiation is provided at least in part by any of borosilicate glass, soda lime glass, silica fusion glass, and aluminum oxide ceramic in thermal communication with at least part of said high intensity discharge lamp.

16. The agricultural field of claim 12, wherein said illuminating originates from, and moves with a moveable cultivator that moves along a field.

17. The agricultural field of claim 12, wherein said exposures of said Medium Wavelength Infrared and said Ultraviolet Illumination Distribution occur at least in part non-simultaneously.
